(19) United States
(12) Patent Application Publication
(10) Pub. No.: US 2025/0227559 A1
(43) Pub. Date: Jul. 10, 2025

(54) METHOD AND APPARATUS FOR EPS PDN CONNECTION CONTEXT INFORMATION UPDATE

(71) Applicant: Telefonaktiebolaget LM Ericsson (publ), Stockholm (SE)

(72) Inventors: Yunjie LU, Shanghai (CN); Yong YANG, Kållered (SE); Chunbo WANG, Shanghai (CN)

(21) Appl. No.: 18/850,355

(22) PCT Filed: Apr. 26, 2023
(86) PCT No.: PCT/CN2023/090851

§ 371 Date: Sep. 24, 2024

(30) Foreign Application Priority Data
Apr. 29, 2022 (WO) PCT/CN2022/090426

(51) Int. Cl. H04W 36/00; H04W 36/30

(52) U.S. Cl. CPC H04W 36/0022; H04W 36/0033; H04W 36/305

(57) ABSTRACT

Embodiments of the present disclosure provide method and apparatus for EPS PDN connection context information update. A method performed by a first session management function (SMF), wherein the first SMF is a home SMF or an anchor SMF, the method includes determining Evolved Packet System (EPS) Packet Data Network (PDN) connection context information of a Protocol Data Unit (PDU) session is changed. The method further includes sending updated EPS PDN connection context information of the PDU session to a second SMF, wherein the second SMF is a visited SMF or an intermediate SMF. The PDU session is currently served by the first SMF and the second SMF.

### CROSS REFERENCE TO RELATED APPLICATIONS

This application is a 35 U.S.C. § 371 national stage application of PCT International Application No. PCT/CN2023/090851 filed on Apr. 26, 2023, which in turn claims foreign priority to International Patent Application No. PCT/CN2022/090426, filed on Apr. 29, 2022, the disclosures and content of which are incorporated by reference herein in their entirety.

### TECHNICAL FIELD

The non-limiting and exemplary embodiments of the present disclosure generally relate to the technical field of communications, and specifically to methods and apparatuses for Evolved Packet System (EPS) Packet Data Network (PDN) connection context information update.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example new radio (NR) as defined by 3rd Generation Partnership Project (3GPP), it has introduced network function (NF) Set based session resilience that the equivalent control plane NFs can be grouped into NF Sets. E.g. several Session Management Function (SMF) instances are grouped into an SMF Set. NFs within a NF Set are interchangeable because they share the same context data. A NF can be replaced by an alternative NF within the same NF Set in the case of scenarios such as failure, load balancing, load re-balancing, etc. An SMF can act as anchor SMF, intermediate SMF (I-SMF), visited SMF (V-SMF), or home SMF (H-SMF) roles for different PDU (protocol data unit) session contexts.

As specified in 3GPP Technical Specification (TS) 29.502 V17.4.0, the disclosure of which is incorporated by reference herein in its entirety, when a PDU session is possibly moving to EPS with N26 interface, the anchor SMF will provide the PDN Connection Context Information to the I-SMF or V-SMF during PDU Session Establishment or I-SMF/V-SMF insertion.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

When Anchor SMF or H-SMF is reselected, the corresponding information in the EPS PDN Connection Context information may be updated, e.g. the IP (internet protocol) address of the S8-c Full Qualified Tunnel Endpoint Identifier (F-TEID) may include the IP of the new anchor SMF or H-SMF, the PDN gateway (PGW) node name (e.g. pgwNodeName) of the different SMFs may be different, etc.

Currently there is no way for the new anchor SMF or H-SMF to inform the I-SMF/V-SMF of the updated EPS PDN Connection Context. If fifth generation (5G) system (5GS) to EPS mobility happens, the access and mobility management function (AMF) will retrieve old EPS PDN Connection Context information from the I-SMF/V-SMF. With the old EPS PDN Connection Context information, the PDU session cannot be moved to EPS because Mobile Management Entity (MME)/serving gateway (SGW) will find the wrong PDN gateway control plane (PGW-C) combined with SMF in EPS.

To overcome or mitigate at least one of above mentioned problems or other problems, a new solution for EPS PDN connection context information update is needed.

In a first aspect of the disclosure, there is provided a method performed by a first session management function (SMF). The first SMF may be a home SMF or an anchor SMF. The method may comprise determining Evolved Packet System (EPS) Packet Data Network (PDN) connection context information of a Protocol Data Unit (PDU) session is changed. The method may further comprise sending updated EPS PDN connection context information of the PDU session to a second SMF. The second SMF may be a visited SMF or an intermediate SMF. The PDU session may be currently served by the first SMF and the second SMF.

In a second aspect of the disclosure, there is provided a method performed by a second session management function (SMF). The second SMF may be a visited SMF or an intermediate SMF. The method may comprise receiving updated EPS PDN connection context information of a PDU session from a first SMF. The first SMF may be a home SMF or an anchor SMF. The method may further comprise updating old EPS PDN connection context information of the PDU session with the updated EPS PDN connection context information of the PDU session. The PDU session may be currently served by the first SMF and the second SMF.

In a third aspect of the disclosure, there is provided a first session management function (SMF). The first SMF may comprise a processor and a memory coupled to the processor. Said memory contains instructions executable by said processor. Said first SMF is operative to determine Evolved Packet System (EPS) Packet Data Network (PDN) connection context information of a Protocol Data Unit (PDU) session is changed. Said first SMF is further operative to send updated EPS PDN connection context information of the PDU session to a second SMF. The PDU session is currently served by the first SMF and the second SMF.

In a fourth aspect of the disclosure, there is provided a second session management function (SMF). The second SMF may comprise a processor and a memory coupled to the processor. Said memory contains instructions executable by said processor. Said second SMF is operative to receive updated EPS PDN connection context information of a PDU session from a first SMF. Said second SMF is further operative to update old EPS PDN connection context information of the PDU session with the updated EPS PDN connection context information of the PDU session. The PDU session is currently served by the first SMF and the second SMF.

In a fifth aspect of the disclosure, there is provided a first SMF. The first SMF may comprise a determining module configured to determine Evolved Packet System (EPS) Packet Data Network (PDN) connection context information of a Protocol Data Unit (PDU) session is changed. The first SMF may further comprise a sending module configured to send updated EPS PDN connection context information of the PDU session to a second SMF. The PDU session is currently served by the first SMF and the second SMF.

In a sixth aspect of the disclosure, there is provided a second SMF. The second SMF may comprise a first receiving module configured to receive updated EPS PDN connection context information of a PDU session from a first SMF. The second SMF may comprise a updating module configured to update old EPS PDN connection context information of the PDU session with the updated EPS PDN connection context information of the PDU session. The PDU session is currently served by the first SMF and the second SMF.

In another aspect of the disclosure, there is provided a computer program product comprising instructions which when executed by at least one processor, cause the at least one processor to perform the method according to any one of the first or second aspects.

In another aspect of the disclosure, there is provided a computer-readable storage medium storing instructions which when executed by at least one processor, cause the at least one processor to perform the method according to any one of the first or second aspects.

Embodiments herein may provide many advantages, of which a non-exhaustive list of examples follows. In some embodiments herein, it allows the anchor SMF/H-SMF to update the V-SMF/I-SMF with updated EPS PDN Connection Context Information. In some embodiments herein, with updated EPS PDN Connection Context Information, the V-SMF/I-SMF can generate the correction General Packet Radio Service (GPRS) Tunneling Protocol (GTP) information to secure the PDU session successfully move to EPS during 5GS to EPS mobility. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a flowchart of PDU session creation;

FIG. 2 schematically shows a roaming 5G system architecture according to an embodiment of the present disclosure;

FIGS. 3-13, FIG. 14a and FIG. 14b show flowcharts of methods according to embodiments of the present disclosure;

FIG. 15 shows a flowchart of PDU session update towards H-SMF or SMF according to an embodiment of the present disclosure;

FIG. 16 shows a flowchart of PDU session update towards V-SMF or I-SMF according to an embodiment of the present disclosure;

FIG. 17 shows a flowchart of PDU session status notification according to an embodiment of the present disclosure;

FIG. 18 shows a flowchart of EPS PDN Connection Context Update in (H-)SMF Update Response according to an embodiment of the present disclosure;

FIG. 19 shows a flowchart of EPS PDN Connection Context Update in V-SMF/I-SMF Update Request according to an embodiment of the present disclosure;

FIG. 20 shows a flowchart of EPS PDN Connection Context Update with Status Notification according to an embodiment of the present disclosure;

FIG. 21 is a block diagram showing an apparatus suitable for practicing some embodiments of the disclosure;

FIG. 22 is a block diagram showing a first SMF according to an embodiment of the disclosure; and

FIG. 23 is a block diagram showing a second SMF according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (access and mobility management function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “may comprise”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

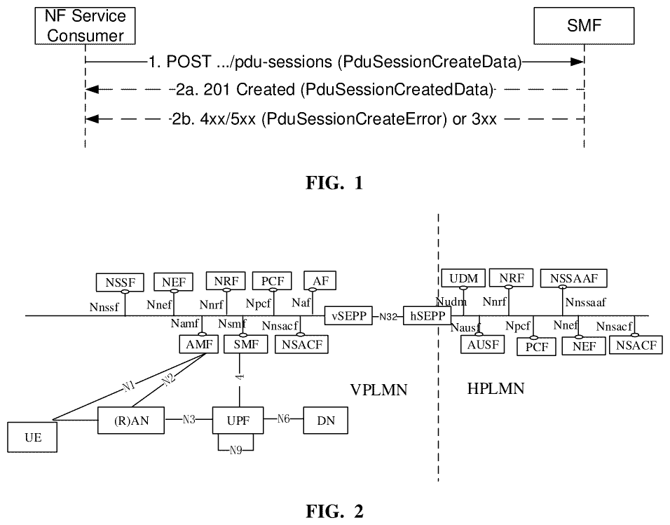

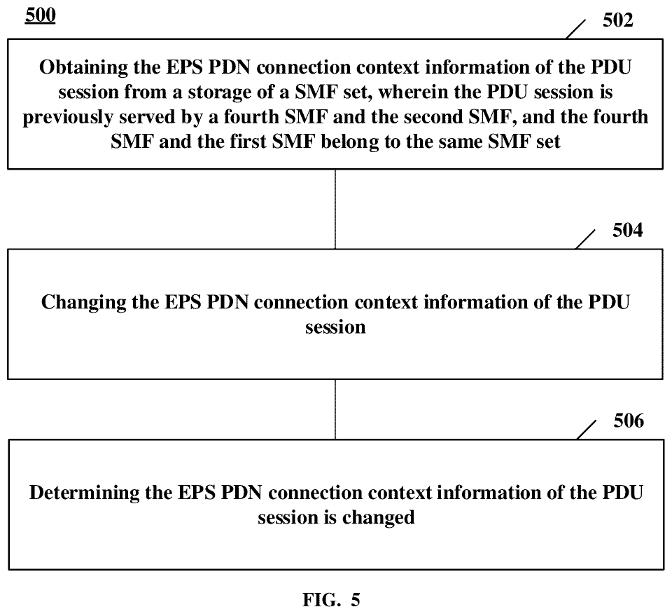

FIG. 1 shows a flowchart of PDU session creation, which is same as FIG. 5.2.2.7.1-1 of 3GPP TS 29.502 V17.4.0. Description to the flowchart and PDU session creation can be referred to Once received the EPS PDN Connection Context, the I-SMF/V-SMF will store it. When AMF retrieves the EPS PDN Context Information from the I-SMF/V-SMF during 5GS to EPS mobility with N26, the I-SMF/V-SMF will generate the GTP content using the locally stored EPS PDN Connection Context received from the anchor SMF.

### Anchor SMF Reselection

In 3GPP Release-16, the NF Set concept is specified to support service redundancy. I.e. the NF instances within the NF set is interchangeable. The resource created on one NF instance can seamlessly restored on another NF instance to continue the service, e.g. when the original NF instance is no longer available.

In PDU Session scenario, when the V-SMF/I-SMF identified that the anchor SMF supporting SMF set is not available, a new anchor SMF within the same SMF set will be reselected to continue the PDU session. Similarly, other network functions, e.g. PCF/UDM/UPF may also reselect a new anchor SMF and the new anchor SMF will subsequently inform I-SMF/V-SMF about the anchor SMF change.

Table 1 shows an example of EPS PDN Connection Context Information, which is same as Table 6.1.6.2.31-1 of 3GPP TS 29.502 V17.4.0. In other embodiment, the EPS PDN Connection Context Information may contain any other suitable attributes or parameters.

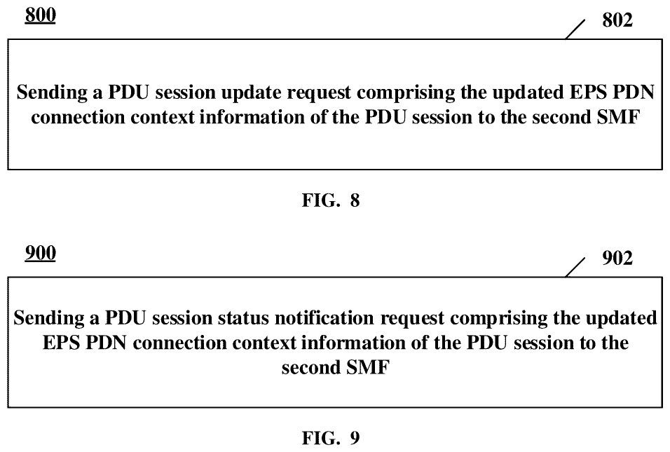

TABLE 1

| Attribute name | Data type | P | Cardinality | Description |
|---|---|---|---|---|
| pgwS8cFteid | Bytes | M | 1 | Base64-encoded characters, encoding the PGW S8 F- |
| | | | | TEID for Control Plane as specified in FIG. 8.22-1 of |
| | | | | 3GPP TS 29.274 [16] (starting from octet 1). |
| pgwNodeName | Bytes | C | 0 . . . 1 | Base64-encoded characters, encoding the PGW FQDN IE |
| | | | | as specified in FIG. 8.66-1 of 3GPP TS 29.274 [16] |
| | | | | (starting from octet 1). It shall be present, if it is available. |
| linkedBearerId | EpsBearerId | C | 0 . . . 1 | An implementation complying with this version of the |
| | | | | specification shall include this attribute and set it to the |
| | | | | default bearer ID associated with the PDU session moved |
| | | | | to EPS. |

As described above, when Anchor SMF or H-SMF is reselected, the corresponding information in the EPS PDN Connection Context information may be updated, e.g. the IP (Internet protocol) address of the S8-c F-TEID may include the IP of the new anchor SMF or H-SMF, the pgwNodeName of the different SMFs may be different, etc.

However currently there is no way for the new anchor SMF or H-SMF to inform the I-SMF/V-SMF of the updated EPS PDN Connection Context. If 5GS to EPS mobility happens, the AMF will retrieve old EPS PDN Connection Context information from the I-SMF/V-SMF. With the old EPS PDN Connection Context information, the PDU session cannot be moved to EPS because MME/SGW will find the wrong PGW-C+SMF in EPS.

To overcome or mitigate at least one of above mentioned problems or other problems, a new solution for EPS PDN connection context information update is needed.

Although the subject matter described herein may be implemented in any appropriate type of system using any suitable components, the embodiments disclosed herein are described in relation to a communication system complied with the exemplary system architecture illustrated in FIG. 2. For simplicity, the system architecture of FIG. 2 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

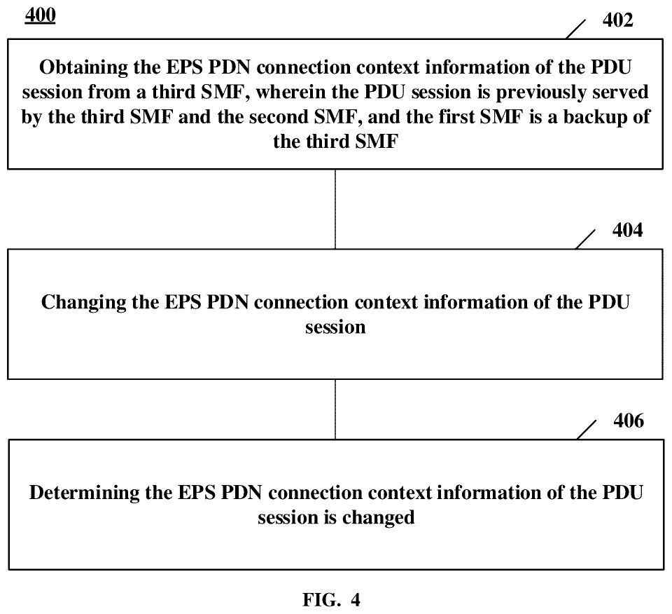

FIG. 2 schematically shows a roaming 5G system architecture according to an embodiment of the present disclosure. The architecture of FIG. 2 is same as FIG. 4.2.4-1 as described in 3GPP TS 23.501 V17.2.0, the disclosure of which is incorporated by reference herein in its entirety. The system architecture of FIG. 2 may comprise some exemplary elements such as AUSF, AMF, DN (data network), NEF, NRF, NSSF, PCF, SMF, UDM, UPF, AF, UE, (R)AN, SCP (Service Communication Proxy), NSACF (Network Slice Admission Control Function), vSEPP (visited Security Edge Protection Proxy), hSEPP (home Security Edge Protection Proxy), etc.

In accordance with an exemplary embodiment, the UE can establish a signaling connection with the AMF over the reference point N1, as illustrated in FIG. 2. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 2, the exemplary system architecture also contains the service-based interfaces such as Nnrf, Nnef, Nausf, Nudm, Npcf, Namf, Nnsacf and Nsmf exhibited by NFs such as the NRF, the NEF, the AUSF, the UDM, the PCF, the AMF, the NSACF and the SMF. In addition, FIG. 2 also shows some reference points such as N1, N2, N3, N4, N6, N32 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 2 may be responsible for functions such as session management, mobility management, authentication, security, etc. The AUSF, AMF, DN, NEF, NRF, NSSF, PCF, SMF, UDM, UPF, AF, UE, (R)AN, SCP, NSACF may include the functionality for example as defined in clause 6.2 of 3GPP TS 23.501 V17.2.0.

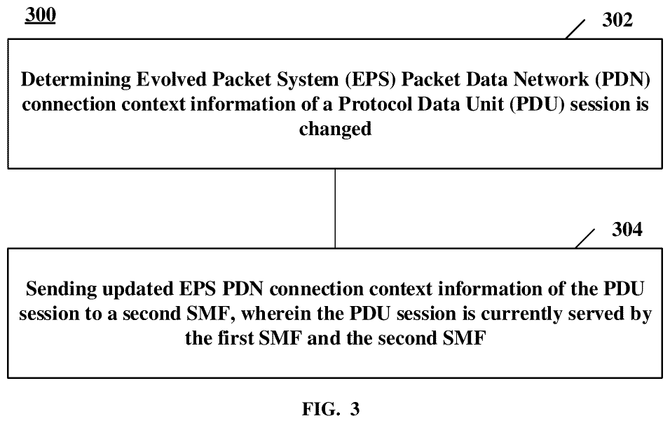

FIG. 3 shows a flowchart of a method according to an embodiment of the present disclosure, which may be performed by an apparatus implemented in or at or as first session management function (SMF) or communicatively coupled to the first SMF. As such, the apparatus may provide means or modules for accomplishing various parts of the method 300 as well as means or modules for accomplishing other processes in conjunction with other components.

At block 302, the first SMF may determine EPS PDN connection context information of a PDU session is changed.

The EPS PDN connection context information may comprise any suitable information and the present disclosure has no limit on it.

In an embodiment, the EPS PDN connection context information of the PDU session may comprise at least one of PDN gateway S8 Fully Qualified Tunnel End Point Identifier for Control Plane, PDN gateway Node Name, or a default bearer identifier (ID) associated with the PDU session moved to EPS. For example, an example of EPS PDN Connection Context Information is shown in Table 1.

If any information of the EPS PDN connection context information of the PDU session is changed, the first SMF may determine the EPS PDN connection context information of the PDU session is changed.

The first SMF may determine EPS PDN connection context information of the PDU session is changed in various ways. For example the first SMF may obtain old EPS PDN connection context information and then change the old EPS PDN connection context information. The first SMF may change the EPS PDN connection context information due to various reasons such as SMF configuration update of the first SMF.

As a first example, if the PDN gateway S8 Fully Qualified Tunnel End Point Identifier for Control Plane is changed, the first SMF may determine EPS PDN connection context information of the PDU session is changed.

As a second example, if the PDN gateway Node Name is changed, the first SMF may determine EPS PDN connection context information of the PDU session is changed.

As a third example, if the default bearer identifier (ID) associated with the PDU session moved to EPS is changed, the first SMF may determine EPS PDN connection context information of the PDU session is changed.

At block 304, the first SMF may send updated EPS PDN connection context information of the PDU session to a second SMF.

The updated EPS PDN connection context information of the PDU session may be comprised in any suitable message such as existing message or new message. For example, The updated EPS PDN connection context information of the PDU session may be comprised in a PDU session update request, a PDU session update response, PDU session status notification request, etc.

The first SMF may send updated EPS PDN connection context information of the PDU session to a second SMF in various ways. For example, the first SMF may send updated EPS PDN connection context information of the PDU session to a second SMF after receiving a request from the second SMF. Alternatively, the first SMF may send updated EPS PDN connection context information of the PDU session to the second SMF immediately when the first SMF determines EPS PDN connection context information of a PDU session is changed.

In an embodiment, the first SMF is a home SMF or an anchor SMF. The second SMF is a visited SMF or an intermediate SMF. For example, the first SMF is a home SMF and the second SMF is a visited SMF. The first SMF is an anchor SMF and the second SMF is an intermediate SMF.

In an embodiment, the PDU session is currently served by the first SMF and the second SMF.

FIG. 4 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 400 as well as means or modules for accomplishing other processes in conjunction with other components. For some parts which have been described in the above embodiments, the description thereof is omitted here for brevity.

At block 402, the first SMF may obtain the EPS PDN connection context information of the PDU session from a third SMF. The PDU session may be previously served by the third SMF and the second SMF. The first SMF may be a backup of the third SMF.

For example, the third SMF can be replaced by the first SMF in the case of scenarios such as failure, load balancing, load re-balancing, etc. In an embodiment, the first SMF and the third SMF may belong to a same SMF set.

At block 404, the first SMF may change the EPS PDN connection context information of the PDU session. For example, the first SMF may change any suitable information of the EPS PDN connection context information of the PDU session.

At block 406, the first SMF may determine the EPS PDN connection context information of the PDU session is changed.

FIG. 5 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 500 as well as means or modules for accomplishing other processes in conjunction with other components. For some parts which have been described in the above embodiments, the description thereof is omitted here for brevity.

At block 502, the first SMF may obtain the EPS PDN connection context information of the PDU session from a storage of a SMF set. The PDU session may be previously served by a fourth SMF and the second SMF. The fourth SMF and the first SMF may belong to the same SMF set.

For example, the fourth SMF can be replaced by the first SMF in the case of scenarios such as failure, load balancing, load re-balancing, etc. The storage of a SMF set may store the same context data which can be accessed by any SMF (or SMF instance) in the SMF set.

At block 504, the first SMF may change the EPS PDN connection context information of the PDU session. For example, the first SMF may change any suitable information of the EPS PDN connection context information of the PDU session.

At block 506, the first SMF may determine the EPS PDN connection context information of the PDU session is changed.

In an embodiment, a failure of the fourth SMF may be detected by the second SMF or a network node.

In an embodiment, the first SMF may be reselected by the second SMF or the network node.

The network node may be any suitable network node. In an embodiment, the network node may comprise at least one of a policy control function (PCF) or a user plane function (UPF) or a Unified Data Management (UDM).

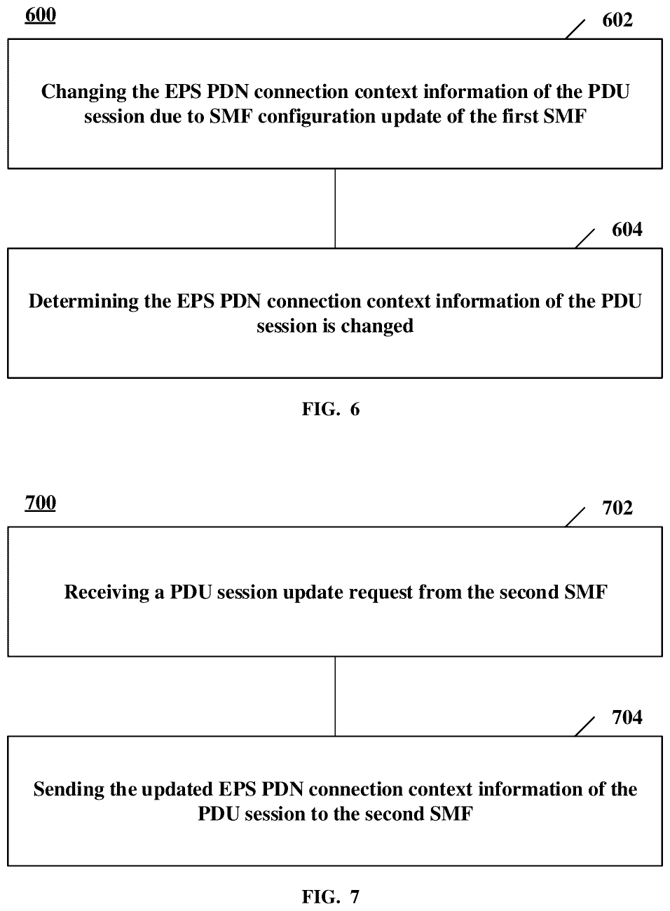

FIG. 6 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 600 as well as means or modules for accomplishing other processes in conjunction with other components. For some parts which have been described in the above embodiments, the description thereof is omitted here for brevity.

At block 602, the first SMF may change the EPS PDN connection context information of the PDU session due to SMF configuration update of the first SMF. The SMF configuration update of the first SMF may comprise any suitable SMF configuration update and the present disclosure has no limit on it.

For example, the SMF configuration update of the first SMF may comprise an update of at least one PDN gateway S8 Fully Qualified Tunnel End Point Identifier for Control Plane, or PDN gateway Node Name, or a default bearer identifier (ID) associated with the PDU session moved to EPS.

At block 604, the first SMF may determine the EPS PDN connection context information of the PDU session is changed.

FIG. 7 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 700 as well as means or modules for accomplishing other processes in conjunction with other components. For some parts which have been described in the above embodiments, the description thereof is omitted here for brevity.

At block 702, the first SMF may receive a PDU session update request from the second SMF. In an embodiment, the PDU session update request may be same as the POST request as described in clause 5.2.2.8.2.1 of 3GPP TS 29.502 V17.4.0.

At block 704, the first SMF may send the updated EPS PDN connection context information of the PDU session to the second SMF.

For example, on success, “204 No Content” or “200 OK” shall be returned; in the latter case, the payload body of the POST response shall contain the representation describing the status of the request and/or information necessary for the NF Service Consumer to send N1 SM signalling to the UE. If the PDU session may be moved to EPS with N26 and the EPS PDN Connection Context information of the PDU session is changed, e.g. due to a new anchor SMF is reselected, the payload shall include the “epsPdnCnxInfo” IE (information element) including the updated EPS PDN Connection Context information. The NF consumer shall refresh the locally stored EPS PDN Connection Context information with the new one if received.

As described in 3GPP TS 23.501 V17.2.0, N26 interface is an inter-CN (core network) interface between the MME and 5GS AMF in order to enable interworking between EPC (Evolved Packet Core) and the NG (next generation) core. Support of N26 interface in the network is optional for interworking. N26 supports subset of the functionalities (essential for interworking) that are supported over S10.

FIG. 8 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 800 as well as means or modules for accomplishing other processes in conjunction with other components. For some parts which have been described in the above embodiments, the description thereof is omitted here for brevity.

At block 802, the first SMF may send a PDU session update request comprising the updated EPS PDN connection context information of the PDU session to the second SMF. In an embodiment, the PDU session update request may be same as the PDU session update request as described in clause 5.2.2.8.3.1 of 3GPP TS 29.502 V17.4.0.

For example, the NF Service Consumer (i.e., the first SMF) shall send a POST request to the resource representing the individual PDU session resource in the V-SMF or I-SMF. The payload body of the POST request shall contain:
the requestIndication IE indicating the request type, which is set to NW_REQ_PDU_SES_MOD;
the modification instructions and/or the information necessary for the V-SMF or I-SMF to send N1 SM signalling to the UE;
the hsmfPduSessionUri IE or smfPduSessionUri IE if the Update Request is sent to the V-SMF or I-SMF before the Create Response, and the H-SMF or SMF PDU session resource URI has not been previously provided to the V-SMF or I-SMF; in this case, the supportedFeatures IE shall also be included if at least one optional feature defined in clause 6.1.8 of 3GPP TS 29.502 V17.4.0 is supported.

If the PDU session may be moved to EPS with N26 and the EPS PDN Connection Context information of the PDU session is changed, e.g. due to a new anchor SMF is reselected, the payload shall include the “epsPdnCnxInfo” IE including the updated EPS PDN Connection Context information. The NF consumer shall refresh the locally stored EPS PDN Connection Context information with the new one if received.

FIG. 9 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 900 as well as means or modules for accomplishing other processes in conjunction with other components. For some parts which have been described in the above embodiments, the description thereof is omitted here for brevity.

At block 902, the first SMF may send a PDU session status notification request comprising the updated EPS PDN connection context information of the PDU session to the second SMF. In an embodiment, the PDU session status notification request may be same as the PDU session status notification as described in clause 5.2.2.10.1 of 3GPP TS 29.502 V17.4.0.

In an embodiment, the first SMF may determine that the PDU session can be moved to EPS with N26. The first SMF may send the updated EPS PDN connection context information of the PDU session to the second SMF.

In an embodiment, the first SMF may receive from the an access and mobility management function (AMF) an indicator indicating that the PDU session can be moved to EPS.

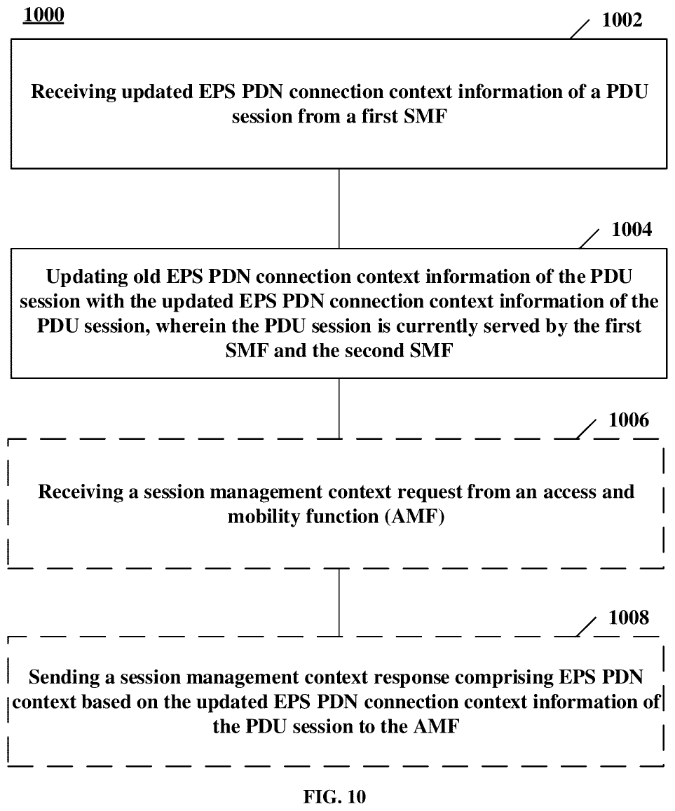

FIG. 10 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1002, the second SMF may receive updated EPS PDN connection context information of a PDU session from a first SMF. For example, as described in the above embodiments, the first SMF may send the updated EPS PDN connection context information of a PDU session to the second SMF, and then the second SMF may receive the updated EPS PDN connection context information of the PDU session from the first SMF.

In an embodiment, the EPS PDN connection context information of the PDU session may comprise at least one of: PDN gateway S8 Fully Qualified Tunnel End Point Identifier for Control Plane, PDN gateway Node Name, or a default bearer identifier (ID) associated with the PDU session moved to EPS.

At block 1004, the second SMF may update (or refresh) old EPS PDN connection context information of the PDU session with the updated EPS PDN connection context information of the PDU session. In this way, the second SMF may obtain and store the correct EPS PDN connection context information of the PDU session.

At block 1006, optionally, the second SMF may receive a session management context request from an access and mobility management function (AMF). For example, when 5GS to EPS mobility happens, the AMF may send the session management context request to the second SMF.

At block 1008, optionally, the second SMF may send a session management context response comprising EPS PDN context based on the updated EPS PDN connection context information of the PDU session to the AMF.

In an embodiment, the PDU session is currently served by the first SMF and the second SMF.

In an embodiment, the first SMF is a home SMF or an anchor SMF and the second SMF is a visited SMF or an intermediate SMF.

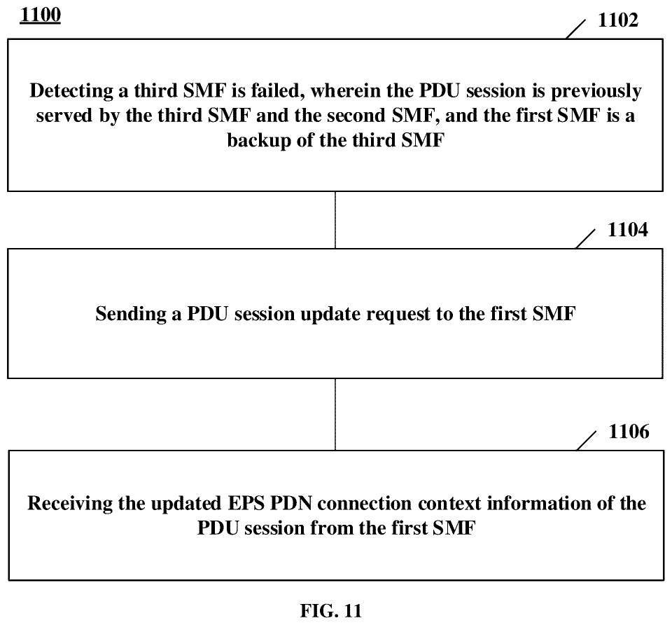

FIG. 11 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the second SMF may detect a third SMF is failed. The PDU session is previously served by the third SMF and the second SMF. The first SMF is a backup of the third SMF. The second SMF may detect the third SMF is failed in various ways. For example, the second SMF may detect the third SMF is failed when it can not receive a heartbeat message or a response message from the third SMF.

At block 1104, the second SMF may send a PDU session update request to the first SMF. The second SMF may know that the first SMF is a backup of the third SMF. In an embodiment, the PDU session update request may be same as the PDU session update request as described in clause 5.2.2.8.2.1 of 3GPP TS 29.502 V17.4.0.

At block 1106, the second SMF may receive the updated EPS PDN connection context information of the PDU session from the first SMF.

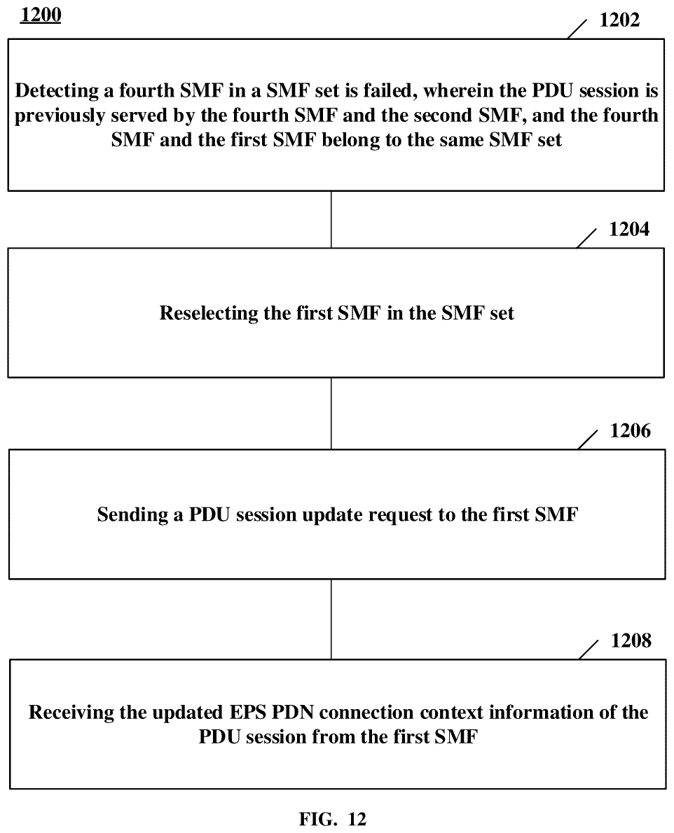

FIG. 12 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the second SMF may detect a fourth SMF in a SMF set is failed. The PDU session is previously served by the fourth SMF and the second SMF. The fourth SMF and the first SMF belong to the same SMF set.

At block 1204, the second SMF may reselect the first SMF in the SMF set.

At block 1206, the second SMF may send a PDU session update request to the first SMF. The PDU session update may be same as the PDU session update as described in clause 5.2.2.8.2.1 of 3GPP TS 29.502 V17.4.0.

At block 1208, the second SMF may receive the updated EPS PDN connection context information of the PDU session from the first SMF.

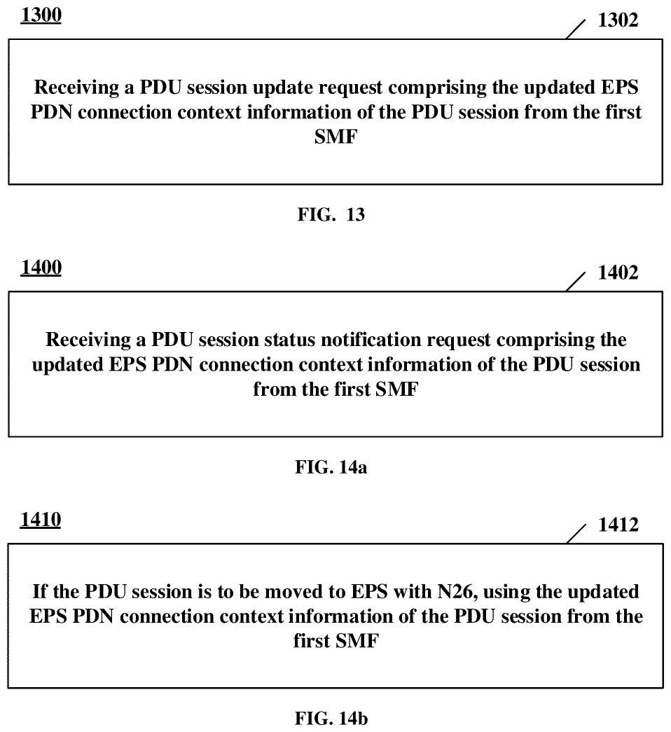

FIG. 13 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1300 as well as means or modules for accomplishing other processes in conjunction with other components. For some parts which have been described in the above embodiments, the description thereof is omitted here for brevity.

At block 1302, the second SMF may receive a PDU session update request comprising the updated EPS PDN connection context information of the PDU session from the first SMF. In an embodiment, the PDU session update request may be same as the PDU session update request as described in clause 5.2.2.8.3.1 of 3GPP TS 29.502 V17.4.0.

FIG. 14a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1400 as well as means or modules for accomplishing other processes in conjunction with other components. For some parts which have been described in the above embodiments, the description thereof is omitted here for brevity.

At block 1402, the second SMF may receive a PDU session status notification request comprising the updated EPS PDN connection context information of the PDU session from the first SMF. In an embodiment, the PDU session status notification request may be same as the PDU session status notification as described in clause 5.2.2.10.1 of 3GPP TS 29.502 V17.4.0.

FIG. 14b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 1410 as well as means or modules for accomplishing other processes in conjunction with other components. For some parts which have been described in the above embodiments, the description thereof is omitted here for brevity.

At block 1412, if the PDU session is to be moved to EPS with N26, the second SMF may use the updated EPS PDN connection context information of the PDU session from the first SMF.

In an embodiment, if (or when) the PDU session can be moved to EPS with N26, the second SMF may receive the updated EPS PDN connection context information of the PDU session from the first SMF.

In an embodiment, the second SMF may receive the updated EPS PDN connection context information of the PDU session from the first SMF due to SMF configuration update of the first SMF.

In an embodiment, the second SMF may receive the updated EPS PDN connection context information of the PDU session from the first SMF due to a failure of a fifth SMF in a SMF set is detected by a network node and the first SMF in the SMF set is reselected by the network node.

In an embodiment, the network node may comprise at least one of a policy control function (PCF) or a user plane function (UPF) or a Unified Data Management (UDM).

In an embodiment, when anchor SMF is changed which leads to EPS PDN Connection Context information change, the new anchor SMF shall inform the V-SMF/I-SMF with the updated EPS PDN Connection Context information.

In an embodiment, when the configuration of the PGW-C+SMF is changed, e.g. new PGW Node Name is configured or new S8-c network interface with different IP address is assigned, the EPS Connection context information should be updated as well.

In an embodiment, the update of changed EPS PDN Connection Context information can be done with different service operations in the following different scenarios:
1. via (H-)SMF Update Response, if the reselection is done by I-SMF/V-SMF with (H) SMF Update request; and
2. via V-SMF/I-SMF Update request, if the reselection of anchor SMF is triggered by other network function and an immediate PDU session update is required (e.g. a policy update from PCF); and
3. via Status Notification to V-SMF/I-SMF, if the reselection of anchor SMF is triggered by other network function and no PDU session update is needed.

In an embodiment, the following content may be added in 3GPP TS 29.502 V17.4.0.

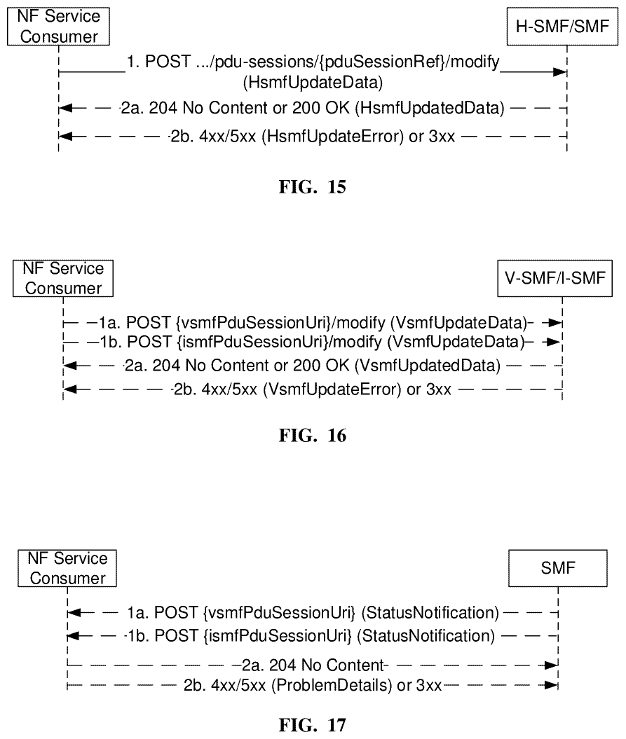

FIG. 15 shows a flowchart of PDU session update towards H-SMF or SMF according to an embodiment of the present disclosure.

The NF Service Consumer (i.e. the V-SMF for a HR (home routed) PDU session, or the I-SMF for a PDU session with an I-SMF) shall update a PDU session in the H-SMF or SMF and/or provide the H-SMF or SMF with information received by the NF Service Consumer in N1 SM signaling from the UE, by using the HTTP POST method (modify custom operation) as shown in FIG. 15.

At step 1. The NF Service Consumer shall send a POST request to the resource representing the individual PDU session resource in the H-SMF or SMF. The payload body of the POST request shall contain:
the requestIndication IE indicating the request type. Unless specified otherwise in clause 5.2.2.8.2 of 3GPP TS 29.502 V17.4.0, the value of the requestIndication IE shall be set to NW_REQ_PDU_SES_MOD;
the modification instructions and/or the information received by the NF Service Consumer in N1 signalling from the UE.

At step 2a. On success, “204 No Content” or “200 OK” shall be returned; in the latter case, the payload body of the POST response shall contain the representation describing the status of the request and/or information necessary for the NF Service Consumer to send N1 SM signalling to the UE. If the PDU session may be moved to EPS with N26 and the EPS PDN Connection Context information of the PDU session is changed, e.g. due to a new anchor SMF is reselected, the payload shall include the “epsPdnCnxInfo” IE including the updated EPS PDN Connection Context information. The NF consumer shall refresh the locally stored EPS PDN Connection Context information with the new one if received.

At step 2b. On failure or redirection, one of the HTTP status code listed in Table 6.1.3.3.3.2-3 of 3GPP TS 29.502 V17.4.0 shall be returned. For a 4xx/5xx response, the message body shall contain an HsmfUpdateError structure, including:
a ProblemDetails structure with the “cause” attribute set to one of the application error listed in Table 6.1.3.3.3.2-3 of 3GPP TS 29.502 V17.4.0;
the n1SmCause IE with the 5GSM cause the H-SMF or SMF proposes the NF Service Consumer to return to the UE, if the request included n1 SmInfoFromUe;
n1SmInfoToUe binary data, if the H-SMF or SMF needs to return NAS SM information which the NF Service Consumer does not need to interpret;
the procedure transaction id that was received in the request, if this is a response sent to a UE requested PDU session modification.

In an embodiment, the following content may be added in 3GPP TS 29.502 V17.4.0.

FIG. 16 shows a flowchart of PDU session update towards V-SMF or I-SMF according to an embodiment of the present disclosure.

The NF Service Consumer (i.e. the H-SMF for a HR PDU session, or the SMF for a PDU session with an I-SMF) shall update a PDU session in the V-SMF or I-SMF and/or provide information necessary for the V-SMF or I-SMF to send N1 SM signaling to the UE, or request to allocate or revoke EPS Bearer ID(s) for the PDU session, by using the HTTP “modify” custom operation as shown in FIG. 16.

At step 1. The NF Service Consumer shall send a POST request to the resource representing the individual PDU session resource in the V-SMF or I-SMF. The payload body of the POST request shall contain:
the requestIndication IE indicating the request type, which is set to NW_REQ_PDU_SES_MOD;
the modification instructions and/or the information necessary for the V-SMF or I-SMF to send N1 SM signalling to the UE;
the hsmfPduSessionUri IE or smfPduSessionUri IE if the Update Request is sent to the V-SMF or I-SMF before the Create Response, and the H-SMF or SMF PDU session resource URI has not been previously provided to the V-SMF or I-SMF; in this case, the supportedFeatures IE shall also be included if at least one optional feature defined in clause 6.1.8 of 3GPP TS 29.502 V17.4.0 is supported.

If the PDU session may be moved to EPS with N26 and the EPS PDN Connection Context information of the PDU session is changed, e.g. due to a new anchor SMF is reselected, the payload shall include the “epsPdnCnxInfo” IE including the updated EPS PDN Connection Context information. The NF consumer shall refresh the locally stored EPS PDN Connection Context information with the new one if received.

At step 2a. On success, “204 No Content” or “200 OK” shall be returned; in the latter case, the payload body of the POST response shall contain the representation describing the status of the request and/or information received by the V-SMF or I-SMF in N1 signalling from the UE.

At step 2b. On failure or redirection, one of the HTTP status code listed in Table 6.1.3.7.4.2.2-1 of 3GPP TS 29.502 V17.4.0 shall be returned. For a 4xx/5xx response, the message body shall contain a VsmfUpdateError structure, including:
a ProblemDetails structure with the “cause” attribute set to one of the application error listed in Table 6.1.3.7.4.2.2-1 of 3GPP TS 29.502 V17.4.0;
the n1SmCause IE with the 5GSM cause returned by the UE, if available;
n1SmInfoFromUe and/or unknownNISmInfo binary data, if NAS SM information has been received from the UE that needs to be transferred to the H-SMF or SMF, or that the V-SMF or I-SMF does not comprehend;
the procedure transaction id received from the UE, if available.

In an embodiment, the following content may be added in 3GPP TS 29.502 V17.4.0.

FIG. 17 shows a flowchart of PDU session status notification according to an embodiment of the present disclosure.

The Notify Status service operation shall be used to notify the NF Service Consumer about status changes of a PDU session (e.g. when the PDU session is released and the release is not triggered by a Release Request, or when the PDU session is moved to another system, or when the control of the PDU session is taken over by another anchor SMF), for a HR PDU session or a PDU session involving an I-SMF.

It is used in the following procedures:
Home network requested PDU Session release (see clause 4.3.4.3 of 3GPP TS 23.502 V17.2.1), e.g. H-SMF initiated release;
SMF requested PDU session release, for a PDU session involving an I-SMF (see clause 4.23 of 3GPP TS 23.502 V17.2.1);
Handover of a PDU Session procedure from 3GPP to untrusted non-3GPP access (see clauses 4.9.2.4.2 and 4.23.16.2 of 3GPP TS 23.502 V17.2.1);
Interworking procedures without N26 interface, e.g. 5GS to EPS Mobility (see clause 4.11.2.2 of 3GPP TS 23.502 V17.2.1);
Handover from 5GC-N3IWF to EPS (see clause 4.11.3.2 of 3GPP TS 23.502 V17.2.1);
Handover from 5GS to EPC/ePDG (see clause 4.11.4.2 of 3GPP TS 23.502 V17.2.1);
The control of PDU session is taken over by a new anchor SMF within the same SMF set (see clause 5.22 of 3GPP TS 29.244 V17.4.0), and the new SMF instance decides to notify the change of SMF;
SMF triggered I-SMF selection or removal (see clause 4.23.5.4 of 3GPP TS 23.502 V17.2.1);
Change of SSC mode 2 PDU Session Anchor with different PDU Sessions (see clause 4.3.5.1 of 3GPP TS 23.502 V17.2.1);
Change of SSC mode 3 PDU Session Anchor with multiple PDU Sessions (see clause 4.3.5.2 of 3GPP TS 23.502 V17.2.1).

The SMF (i.e. H-SMF for a HR PDU session, or SMF for a PDU session involving an I-SMF) shall notify the NF Service Consumer (i.e. V-SMF for a HR PDU session, or I-SMF for a PDU session involving an I-SMF) by using the HTTP POST method as shown in FIG. 5.2.2.10-1 of 3GPP TS 29.502 V17.4.0.

At step 1. The SMF shall send a POST request to the resource representing the individual PDU session resource in the NF Service Consumer. The payload body of the POST request shall contain the notification payload, with the status information.

If the notification is triggered by PDU session handover to release resources of the PDU Session in the source access, the notification payload shall contain the resourceStatus IE with the value “RELEASED” and the Cause IE with value “PDU_SESSION_HANDED_OVER” as specified in clause 4.2.9.4.2 of 3GPP TS 23.501 V17.2.0.

If the notification is triggered by PDU session handover to release only the SM Context with the I-SMF in the source access but without releasing the PDU session in the AMF, the notification payload shall contain the resourceStatus IE with the value “UPDATED” and the Cause IE with the value “PDU_SESSION_HANDED_OVER” as specified in clause 4.23.16.2 of 3GPP TS 23.502 V17.2.1.

If the notification is triggered by SMF for I-SMF selection or removal for the current PDU session, or SMF selection during PDU Session re-establishment for SSC mode 2/3, the notification payload shall contain the resourceStatus IE with the value “UNCHANGED”, the Cause IE with the value “TARGET_DNAI_NOTIFICATION” and the targetDnaiInfo IE. The targetDnai IE in the targetDnaiInfo IE shall be absent if the I-SMF removal is triggered due to the DNAI currently served by the I-SMF being no longer used for the PDU Session. If the notification is triggered for SMF selection during PDU Session re-establishment for SSC mode 3, the notification payload may also contain the oldPduSessionRef IE as specified in clause 4.3.5.2 of 3GPP TS 23.502 V17.2.1.

If the notification is triggered by PDU session handover to release resources of the PDU Session in the target access due to handover failure between 3GPP access and non-3GPP access, the notification payload shall contain the resourceStatus IE with the value “RELEASED” and the Cause IE with the value “PDU_SESSION_HAND_OVER_FAILURE”.

If the NF Service Consumer indicated support of the HOFAIL feature (see clause 6.1.8) and if the notification is triggered by PDU session handover to update access type of the PDU Session due to handover failure between 3GPP access and non-3GPP access, the notification payload shall contain the resourceStatus IE with the value “UPDATED”, the anType IE with the value “3GPP” or “NON_3GPP” indicating the access type of the PDU session after the handover failure scenario and the Cause IE with the value “PDU_SESSION_HAND_OVER_FAILURE”.

If upon a change of anchor SMF, the new anchor SMF instance decides to notify the change of anchor SMF, then the notification payload shall contain the resourceStatus IE with the value “UPDATED” and the Cause IE with the value “CHANGED_ANCHOR_SMF”. In addition, the new anchor SMF instance shall include its SMF Instance ID in the notification payload, and/or carry an updated binding indication in the HTTP headers to indicate the change of anchor SMF (as per step 6 of clause 6.5.3.3 of 3GPP TS 29.500 V17.6.0). If the PDU session may be moved to EPS with N26 and the EPS PDN Connection Context information of the PDU session on the new anchor SMF is different from the one on the old anchor SMF, the payload shall also include the “epsPdnCnxInfo” IE including the updated EPS PDN Connection Context information. The NF consumer shall refresh the locally stored EPS PDN Connection Context information with the new one if received.

At step 2a. On success, “204 No Content” shall be returned and the payload body of the POST response shall be empty.

If the SMF indicated in the request that the PDU session in the SMF is released, the NF Service Consumer shall release the SM context for the PDU session.

If the SMF indicated in the request that the SM context resource is updated with the anType IE, the NF Service Consumer shall change the access type of the PDU session with the value of anType IE.

At step 2b. On failure or redirection, one of the HTTP status code listed in Table 6.1.3.7.3.1-2 of 3GPP TS 29.502 V17.4.0shall be returned. For a 4xx/5xx response, the message body shall contain a ProblemDetails structure with the “cause” attribute set to one of the application errors listed in Table 6.1.3.7.3.1-2 of 3GPP TS 29.502 V17.4.0.

In an embodiment, the following content may be added in Table 6.1.6.2.12-1 of 3GPP TS 29.502 V17.4.0.

TABLE 6.1.6.2.12-1
Definition of type HsmfUpdatedData

| | | | | | |
|---|---|---|---|---|---|
| Attribute name | Data type | P | Cardinality | Description | Applicability |

| | | | | |
|---|---|---|---|---|
| epsPdnCnxInfo | EpsPdnCnxInfo | C | 0 . . . 1 | This IE shall be present during a handover from non- |
| | | | | 3GPP access to 3GPP access, if the PDU session may be |
| | | | | moved to EPS during its lifetime. |
| | | | | (NOTE 1) |
| | | | | The IE shall also be included when the EPS PDN |
| | | | | Connection Context Information of the PDU session is |
| | | | | changed, e.g. due to reselection of anchor SMF. |

In an embodiment, the following content may be added in Table 6.1.6.2.15-1 of 3GPP TS 29.502 V17.4.0.

TABLE 6.1.6.2.15-1

| | | | | | |
|---|---|---|---|---|---|
| Attribute name | Data type | P | Cardinality | Description | Applicability |

| | | | | |
|---|---|---|---|---|
| epsPdnCnxInfo | EpsPdnCnxInfo | C | 0 . . . 1 | This IE shall be present if the PDU session may be |
| | | | | moved to EPS during its lifetime and the |
| | | | | EpsInterworkingIndication is changed to “WITH_N26”. |
| | | | | The IE shall also be present when the EPS PDN |
| | | | | Connection Context Information of the PDU session is |
| | | | | changed, e.g. due to change of anchor SMF. |

In an embodiment, the following content may be added in Table 6.1.6.2.17-1 of 3GPP TS 29.502 V17.4.0.

TABLE 6
1.6.2.17-1

| Attribute name | Data type | P | Cardinality | Description | Applicability |
|---|---|---|---|---|---|
| epsPdnCnxInfo | EpsPdnCnxInfo | C | 0 . . . 1 | This IE may be present if the resourceStatus attribute | ES3XX |
| | | | | in statusInfo is set to “UPDATED” and the cause IE in | |
| | | | | statusInfo is set to “CHANGED_ANCHOR_SMF”. | |
| | | | | When present, this IE shall include the EPS PDN | |
| | | | | Connection Context Information of the PDU session | |
| | | | | on the new anchor SMF. | |

In an embodiment, the Nsmf_PDUSession API of 3GPP TS 29.502 V17.4.0 may be amended as following.

### A.2 Nsmf_PDUSession API

```
openapi: 3.0.0
**************** Text Skipped for Clarity ********************
  StatusNotification:
    description: Data within Notify Status Request
    type: object
    properties:
      statusInfo :
        $ref: ‘#/components/schemas/StatusInfo’
      smallDataRateStatus:
        $ref: ‘TS29571_CommonData.yaml#/components/schemas/SmallDataRateStatus'
      apnRateStatus:
        $ref: ‘TS29571_CommonData.yaml#/components/schemas/ApnRateStatus'
      targetDnaiInfo:
        $ref: ‘#/components/schemas/TargetDnaiInfo’
      oldPduSessionRef:
        $ref: ‘TS29571_CommonData.yaml#/components/schemas/Uri’
      newSmfId:
        $ref: ‘TS29571_CommonData.yaml#/components/schemas/NfInstanceId’
      epsPdnCnxInfo:
        $ref: ‘#/components/schemas/EpsPdnCnxInfo’
      interPlmnApiRoot:
        $ref: ‘TS29571_CommonData.yaml#/components/schemas/Uri’
      intraPlmnApiRoot:
        $ref: ‘TS29571_CommonData.yaml#/components/schemas/Uri’
    required:
      - statusInfo
**************** Text Skipped for Clarity ********************
```

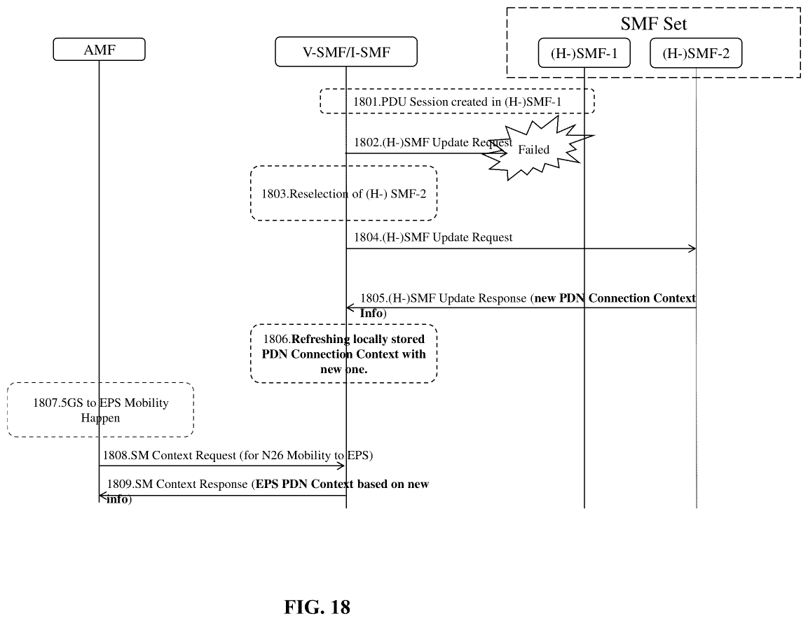

FIG. 18 shows a flowchart of EPS PDN Connection Context Update in (H-)SMF Update Response according to an embodiment of the present disclosure.

At step 1801. PDU Session created in (H-)SMF-1.

At step 1802. V-SMF/I-SMF sends (H-)SMF Update Request to (H-)SMF-1. However (H-)SMF-1 is failed and V-SMF/I-SMF cannot receive a response from (H-)SMF-1. (H-)SMF-1 detects that (H-)SMF-1 is failed.

At step 1803. V-SMF/I-SMF reselects (H-)SMF-2 in the same SMF set.

At step 1804. V-SMF/I-SMF sends Update Request to (H-)SMF-2.

At step 1805. (H-)SMF-2 sends Update Response (new PDN Connection Context Info) to V-SMF/I-SMF.

At step 1806. V-SMF/I-SMF refreshes locally stored PDN Connection Context with new one.

At step 1807. 5GS to EPS Mobility happens.

At step 1808. AMF sends SM Context Request (for N26 Mobility to EPS) to V-SMF/I-SMF.

At step 1809. V-SMF/I-SMF sends SM Context Response (EPS PDN Context based on new info) to AMF. And then the AMF obtain the correct EPS PDN Context.

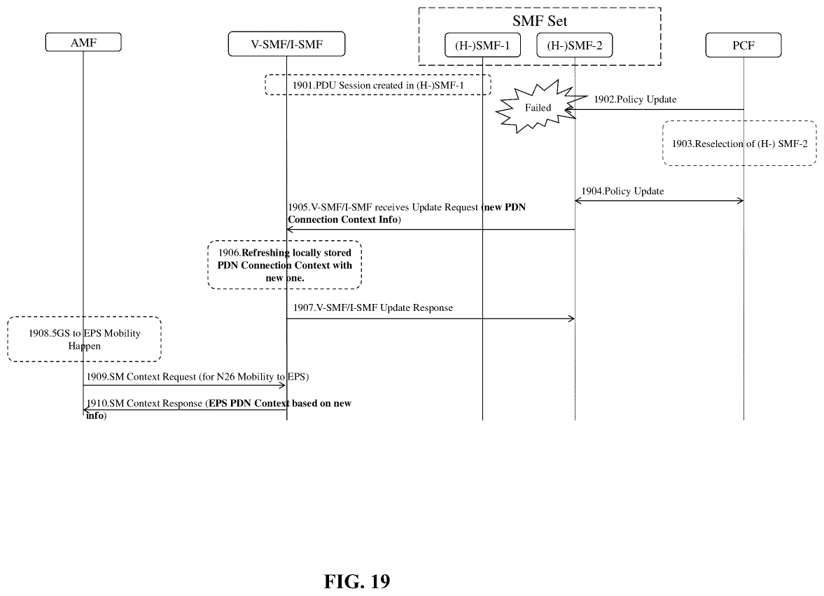

FIG. 19 shows a flowchart of EPS PDN Connection Context Update in V-SMF/I-SMF Update Request according to an embodiment of the present disclosure.

At step 1901. PDU Session is created in (H-)SMF-1.

At step 1902. PCF sends Policy Update to (H-)SMF-1. However (H-)SMF-1 is failed and PCF can not receive a response from (H-)SMF-1. PCF detects that (H-)SMF-1 is failed.

At step 1903. PCF reselects (H-)SMF-2 in the same SMF set.

At step 1904. PCF sends Policy Update request to (H-)SMF-2 and receives response from (H-)SMF-2.

At step 1905. V-SMF/I-SMF receives Update Request (new PDN Connection Context Info) from (H-)SMF-2.

At step 1906. V-SMF/I-SMF refreshes locally stored PDN Connection Context with new one.

At step 1907. V-SMF/I-SMF sends Update Response to (H-)SMF-2.

At step 1908. 5GS to EPS Mobility happens.

At step 1909. AMF sends SM Context Request (for N26 Mobility to EPS) to V-SMF/I-SMF.

At step 1910. V-SMF/I-SMF sends SM Context Response (EPS PDN Context based on new info) to AMF. And then the AMF obtains the correct EPS PDN Context.

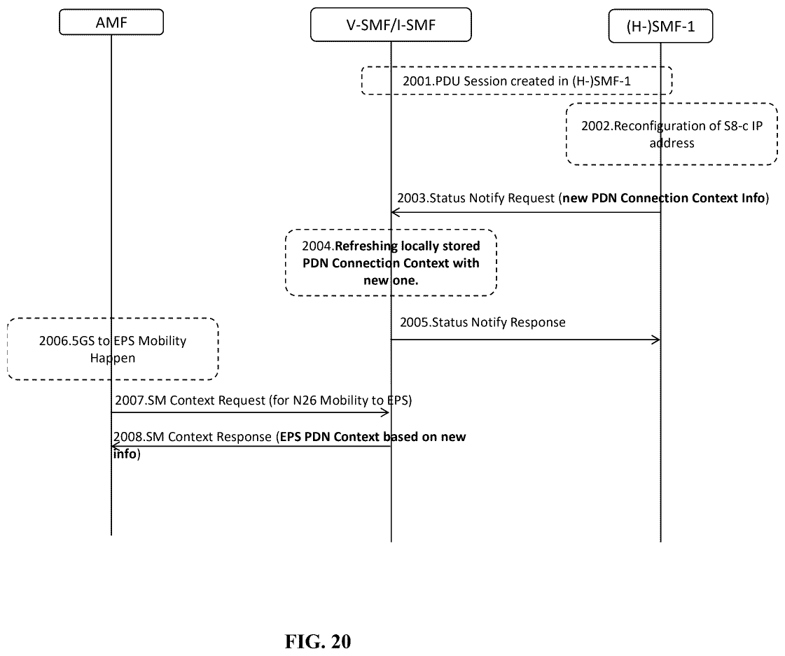

FIG. 20 shows a flowchart of EPS PDN Connection Context Update with Status Notification according to an embodiment of the present disclosure.

At step 2001. PDU Session is created in (H-)SMF-1.

At step 2002. (H-)SMF-1 reconfigures S8-c IP address.

At step 2003. (H-)SMF-1 sends Status Notify Request (new PDN Connection Context Info) to V-SMF/I-SMF.

At step 2004. V-SMF/I-SMF refreshes locally stored PDN Connection Context with new one.

At step 2005. V-SMF/I-SMF sends Status Notify Response to (H-)SMF-1.

At step 2006. 5GS to EPS Mobility happens.

At step 2007. AMF sends SM Context Request (for N26 Mobility to EPS) to V-SMF/I-SMF.

At step 2008. V-SMF/I-SMF sends SM Context Response (EPS PDN Context based on new info) to AMF. And then the AMF obtains the correct EPS PDN Context.

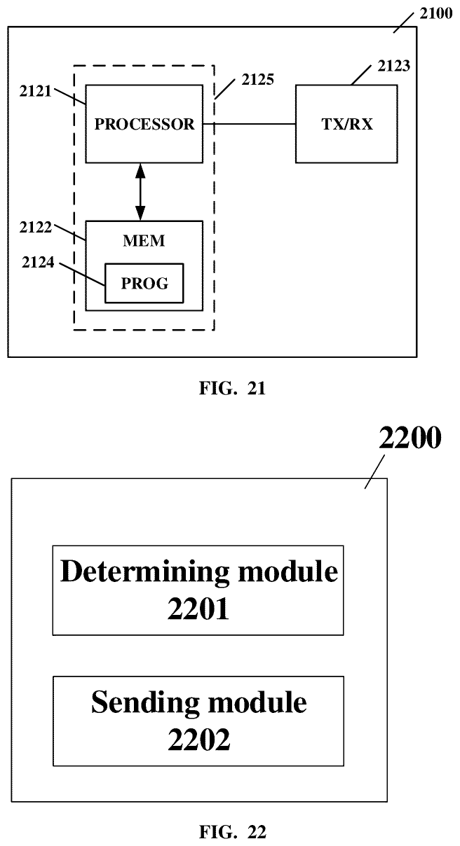

FIG. 21 is a block diagram showing an apparatus suitable for practicing some embodiments of the disclosure. For example, any one of the first SMF or the second SMF described above may be implemented as or through the apparatus 4300.

The apparatus 4300 may comprise at least one processor 2121, such as a digital processor (DP), and at least one memory (MEM) 2122 coupled to the processor 2121. The apparatus 2100 may further comprise a transmitter TX and receiver RX 2123 coupled to the processor 2121. The MEM 2122 stores a program (PROG) 2124. The PROG 2124 may include instructions that, when executed on the associated processor 2121, enable the apparatus 2100 to operate in accordance with the embodiments of the present disclosure. A combination of the at least one processor 2121 and the at least one MEM 2122 may form processing means 2125 adapted to implement various embodiments of the present disclosure.

Various embodiments of the present disclosure may be implemented by computer program executable by one or more of the processor 2121, software, firmware, hardware or in a combination thereof.

The MEM 2122 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 2121 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the first SMF, the memory 2122 contains instructions executable by the processor 2121, whereby the first SMF operates according to any of the methods related to the first SMF as described above.

In an embodiment where the apparatus is implemented as or at the second SMF, the memory 2122 contains instructions executable by the processor 2121, whereby the second SMF operates according to any of the methods related to the second SMF as described above.

FIG. 22 is a block diagram showing a first SMF according to an embodiment of the disclosure. As shown, the first SMF 2200 may comprise a determining module 2201 configured to determine Evolved Packet System (EPS) Packet Data Network (PDN) connection context information of a Protocol Data Unit (PDU) session is changed. The first SMF 2200 may further comprise a sending module 2202 configured to send updated EPS PDN connection context information of the PDU session to a second SMF. The PDU session is currently served by the first SMF and the second SMF.

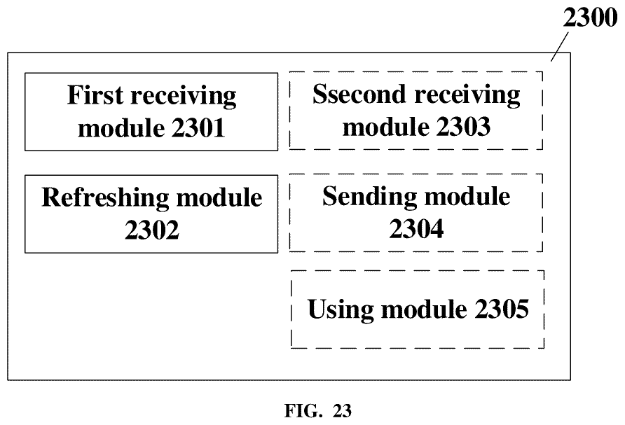

FIG. 23 is a block diagram showing a second SMF according to an embodiment of the disclosure. As shown, the second SMF 2300 may comprise a first receiving module 2301 configured to receive updated EPS PDN connection context information of a PDU session from a first SMF. The second SMF 2300 may comprise a refreshing module 2302 configured to refreshing old EPS PDN connection context information of the PDU session with the updated EPS PDN connection context information of the PDU session. The PDU session is currently served by the first SMF and the second SMF.

In an embodiment, the second SMF 2300 may further comprise a second receiving module 2303 configured to receive a session management context request from an access and mobility management function (AMF).

In an embodiment, the second SMF 2300 may further comprise a sending module 2304 configured to send a session management context response comprising EPS PDN context based on the updated EPS PDN connection context information of the PDU session to the AMF.

In an embodiment, the second SMF 2300 may further comprise a using module 2305 configured to use the updated EPS PDN connection context information of the PDU session from the first SMF if the PDU session is to be moved to EPS with N26.

Embodiments herein may provide many advantages, of which a non-exhaustive list of examples follows. In some embodiments herein, it allows the anchor SMF/H-SMF to update the V-SMF/I-SMF with updated EPS PDN Connection Context Information. In some embodiments herein, with updated EPS PDN Connection Context Information, the V-SMF/I-SMF can generate the correction General Packet Radio Service (GPRS) Tunneling Protocol (GTP) information information to secure the PDU session successfully move to EPS during 5GS to EPS mobility. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the first SMF or the second SMF may not need a fixed processor or memory, any computing resource and storage resource may be arranged from the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1.-32. (canceled)

33. A method performed by a first session management function, SMF, wherein the first SMF is a home SMF or an anchor SMF, comprising:
determining Evolved Packet System, EPS, Packet Data Network, PDN, connection context information of a Protocol Data Unit, PDU, session is changed; and
sending updated EPS PDN connection context information of the PDU session to a second SMF, wherein the second SMF is a visited SMF or an intermediate SMF;
wherein the PDU session is currently served by the first SMF and the second SMF.

34. The method according to claim 33, wherein determining EPS PDN connection context information of the PDU session is changed comprises:
obtaining the EPS PDN connection context information of the PDU session from a third SMF, wherein the PDU session is previously served by the third SMF and the second SMF, and the first SMF is a backup of the third SMF;
changing the EPS PDN connection context information of the PDU session; and
determining the EPS PDN connection context information of the PDU session is changed.

35. The method according to claim 33, wherein determining EPS PDN connection context information of the PDU session is changed comprises:
obtaining the EPS PDN connection context information of the PDU session from a storage of a SMF set, wherein the PDU session is previously served by a fourth SMF and the second SMF, and the fourth SMF and the first SMF belong to the same SMF set;
changing the EPS PDN connection context information of the PDU session; and
determining the EPS PDN connection context information of the PDU session is changed.

36. The method according to claim 35, wherein a failure of the fourth SMF is detected by the second SMF or a network node and/or the first SMF is reselected by the second SMF or the network node.

37. The method according to claim 33, wherein determining EPS PDN connection context information of the PDU session is changed comprises:
changing the EPS PDN connection context information of the PDU session due to SMF configuration update of the first SMF; and
determining the EPS PDN connection context information of the PDU session is changed.

38. The method according to claim 33, wherein sending updated EPS PDN connection context information of the PDU session to a second SMF comprises:
receiving a PDU session update request from the second SMF; and
sending the updated EPS PDN connection context information of the PDU session to the second SMF.

39. The method according to claim 33, wherein sending updated EPS PDN connection context information of the PDU session to a second SMF comprises:
sending a PDU session update request comprising the updated EPS PDN connection context information of the PDU session to the second SMF; or
sending a PDU session status notification request comprising the updated EPS PDN connection context information of the PDU session to the second SMF.

40. The method according to claim 33, wherein sending updated EPS PDN connection context information of the PDU session to a second SMF comprises:
determining that the PDU session can be moved to EPS with N26; and
sending the updated EPS PDN connection context information of the PDU session to the second SMF.

41. A method performed by a second session management function, SMF, wherein the second SMF is a visited SMF or an intermediate SMF, comprising:
receiving updated EPS PDN connection context information of a PDU session from a first SMF, wherein the first SMF is a home SMF or an anchor SMF; and
updating old EPS PDN connection context information of the PDU session with the updated EPS PDN connection context information of the PDU session,
wherein the PDU session is currently served by the first SMF and the second SMF.

42. The method according to claim 41, wherein receiving the updated EPS PDN connection context information of the PDU session from the first SMF comprises:
detecting a third SMF is failed, wherein the PDU session is previously served by the third SMF and the second SMF, and the first SMF is a backup of the third SMF;
sending a PDU session update request to the first SMF; and
receiving the updated EPS PDN connection context information of the PDU session from the first SMF.

43. The method according to claim 41, wherein receiving the updated EPS PDN connection context information of the PDU session from the first SMF comprises:
detecting a fourth SMF in a SMF set is failed, wherein the PDU session is previously served by the fourth SMF and the second SMF, and the fourth SMF and the first SMF belong to the same SMF set;
reselecting the first SMF in the SMF set;
sending a PDU session update request to the first SMF; and
receiving the updated EPS PDN connection context information of the PDU session from the first SMF.

44. The method according to claim 41, wherein receiving the updated EPS PDN connection context information of the PDU session from the first SMF comprises:
receiving a PDU session update request comprising the updated EPS PDN connection context information of the PDU session from the first SMF; or
receiving a PDU session status notification request comprising the updated EPS PDN connection context information of the PDU session from the first SMF.

45. The method according to claim 41, wherein receiving the updated EPS PDN connection context information of the PDU session from the first SMF comprises:
if the PDU session can be moved to EPS with N26, receiving the updated EPS PDN connection context information of the PDU session from the first SMF and/or using the updated EPS PDN connection context information of the PDU session from the first SMF.

46. The method according to claim 41, wherein receiving the updated EPS PDN connection context information of the PDU session from the first SMF comprises:
receiving the updated EPS PDN connection context information of the PDU session from the first SMF due to SMF configuration update of the first SMF; or
receiving the updated EPS PDN connection context information of the PDU session from the first SMF due to a failure of a fifth SMF in a SMF set is detected by a network node and the first SMF in the SMF set is reselected by the network node.

47. The method according to claim 41, further comprising:
receiving a session management context request from an access and mobility management function, AMF; and
sending a session management context response comprising EPS PDN context based on the updated EPS PDN connection context information of the PDU session to the AMF.

48. A first session management function, SMF, wherein the first SMF is a home SMF or an anchor SMF, comprising:
a processor; and
a memory coupled to the processor, said memory containing instructions executable by said processor, whereby said first SMF is operative to:
determine Evolved Packet System (EPS) Packet Data Network, PDN, connection context information of a Protocol Data Unit, PDU, session is changed; and
send updated EPS PDN connection context information of the PDU session to a second SMF, wherein the second SMF is a visited SMF or an intermediate SMF;
wherein the PDU session is currently served by the first SMF and the second SMF.
